(19) United States
(12) Patent Application Publication
(10) Pub. No.: US 2007/0029301 A1
(43) Pub. Date: Feb. 8, 2007

(54) Terminal mounting structure for a window pane

(76) Inventors: Junichi Tokiwa, Tokyo (JP); Yasukazu Kanatani, Tokyo (JP); Takanori Tanaka, Aichi-ken (JP); Kiyoko Tanaka, Toyota-shi (JP)

Correspondence Address: FULBRIGHT & JAWORSKI, LLP, 666 FIFTH AVE, NEW YORK, NY, 10103-3198, US

(21) Appl. No.: 11/484,895

(22) Filed: Jul. 11, 2006

(30) Foreign Application Priority Data
Jul. 11, 2005 (JP) 2005-201829

(51) Int. Cl. H05B 3/00

(52) U.S. Cl. 219/219

(57) ABSTRACT

A terminal mounting structure for a window pane for reliable attaching a terminal to a glass surface of the window pane using minimal numbers of parts and manufacturing steps. The terminal mounting structure for a window pane has a terminal for electric connection, which is in contact with a conductive part provided on a glass surface of the window pane. The terminal mounting structure is fixed to the glass surface through a resin material attached to the glass surface.

### TECHNICAL FIELD

This invention relates to a terminal mounting structure for a window pane comprising a terminal for electric connection in contact with a conductive part provided on a glass surface of the window pane, and fixed to the glass surface through a resin material attached to the glass surface.

### BACKGROUND OF THE INVENTION

A terminal mounting structure for a window pane is need, for example, when attaching a terminal for electric connection to a glass surface of a rear window pane of an automobile to arrange a defogging heating wire or an antenna wire on the window pane.

Conventionally, with this type of terminal mounting structure, it has been common practice to solder a terminal to a conductive part provided on the glass surface. However, when soldering is carried out in a defective manner, there is a possibility of internal stress remaining in the terminal and causing a strength reduction of the terminal. Further, since the terminal is bare, a cover is required under certain circumstances.

A proposal has been made to place a terminal in contact with a conductive part, attach a case formed of a synthetic resin to the conductive part by using double-sided tape, and insert a pressurizing piece consisting of a spring material between the case and terminal to press resiliently the terminal on the conductive part (see Japanese Unexamined Patent Publication H10-40977, for example).

It has also been proposed to mount a terminal inside a case, place the case on a glass surface with the terminal contacting a conductive part, inserts these elements into a forming die, injects a resin, and fix the case to the glass surface with an injection product formed by the injection molding (see Japanese Utility Model Publication H6-35722, for example).

However, the conventional structure described in Japanese Unexamined Patent Publication H10-40977 requires the case in addition to the terminal, and the case needs to be constructed of a base and a lid. Further, it is necessary to assemble the terminal, pressurizing piece and so on in a predetermined way in the case. Thus, this structure has a drawback that workability is poor and cost is high because of an increase in the number of parts, and complicated assembly operation.

Similarly, the conventional structure described in Japanese Utility Model Publication H6-35722 also has a drawback that, since it is necessary to perform the injection molding after mounting the terminal as desired in a predetermined part inside the case, cost is increased by the complicated assembly operation and increased manufacturing steps.

### OBJECT AND SUMMARY OF THE INVENTION

The present invention overcomes the drawbacks of the prior art, and its object is to provide a terminal mounting structure for a window pane, which can reliably attach a terminal to a glass surface of the window pane using minimal numbers of parts and manufacturing steps.

In accordance with an embodiment of the present invention, a terminal mounting structure for a window pane comprises a terminal for electric connection, which is in contact with a conductive part provided on a glass surface of the window pane. The terminal mounting structure is fixed to the glass surface through a resin material attached to the glass surface. The terminal is formed of a spring material and comprises deformation allowance regions formed on back surfaces of contact portions of the terminal, which is in contact with the conductive part for allowing elastic deformation of the terminal. The resin material surrounds at least the contact portions and the deformation allowance regions of the terminal.

In accordance with an embodiment of the present invention, the terminal for electric connection is formed of a spring material and comprises deformation allowance regions formed on back surfaces of contact portions of the terminal, which is in contact with the conductive part for allowing elastic deformation of the terminal. The resin material surrounds the terminal and the deformation allowance regions. Therefore, only required components of the terminal mounting structure of the present invention are the terminal formed of a spring material and a device for forming the deformation allowance regions, e.g., elastically deformable block-like elements.

The elastically deformable block-like elements can be arranged on the back surfaces of the terminal. The terminal and deformation allowance regions can be surrounded by injection molding of a resin. As a result, the terminal of the present invention can be reliably attached to the glass surface using minimal numbers of parts and manufacturing steps, thereby achieving a cost reduction.

In accordance with an embodiment of the present invention, a terminal mounting structure for a window pane comprises a terminal for electric connection, which is in contact with a conductive part provided on a glass surface of the window pane. The terminal mounting structure is fixed to the glass surface through a resin material attached to the glass surface. The terminal has elastic elements arranged on back surfaces of contact portions of the terminal, which is in contact with the conductive part for pressing, with elastic force, the terminal on the conductive part. The resin material surrounds at least the contact portions and the elastic elements of the terminal.

In accordance with an embodiment of the present invention, the terminal for electric connection has elastic elements arranged on back surfaces of contact portions of the terminal, which is in contact with the conductive part for pressing, with elastic force, the terminal on the conductive part. The resin material surrounds the terminal and the elastic elements. Thus, only required components of the present invention are the terminal and elastic elements. The elastic elements can be arranged on the back surfaces of the terminal, and the terminal and elastic elements can be surrounded by injection molding of a resin. This construction can achieve a cost reduction using minimal numbers of parts and manufacturing steps.

In accordance with an embodiment of the present invention, a terminal mounting structure for a window pane comprises a terminal for electric connection, which is in contact with a conductive part provided on a glass surface of the window pane. The terminal mounting structure is fixed to the glass surface through a resin material attached to the glass surface. The terminal has contact portions, which is in contact with the conductive part and is formed of conductive rubber. The resin material surrounds at least the contact portions of the terminal.

In accordance with an embodiment of the present invention, the terminal for electric connection has contact portions, which is in contact with the conductive part and formed of conductive rubber. The terminal is surrounded by the resin material. Thus, only part of the terminal can be formed of conductive rubber and the injection molding of a resin surrounds the terminal. This construction can achieve a cost reduction by further reducing the number of parts.

Various other objects, advantages and features of the present invention will become readily apparent from the ensuing detailed description, and the novel features will be particularly pointed out in the appended clams.

### BRIEF DESCRIPTION OF THE DRAWINGS

The following detailed description, given by way of example, and not intended to limit the present invention solely thereto, will best be understood in conjunction with the accompanying drawings in which:

FIG. 1 is a sectional view of a terminal mounting structure in accordance with an exemplary embodiment of the present invention;

FIG. 2 is a perspective view of the terminal mounting structure of FIG. 1 in accordance with an exemplary embodiment of the present invention;

FIG. 3 is an explanatory view showing a manufacturing process of the terminal mounting structure in accordance with an exemplary embodiment of the present invention;

FIG. 4 is a sectional view showing the manufacture process of the terminal mounting structure of FIG. 3 in accordance with an exemplary embodiment of the present invention;

FIG. 5 is a sectional view of a terminal mounting structure in accordance with an exemplary embodiment of the present invention;

FIG. 6 is a sectional view of a terminal mounting structure in accordance with an exemplary embodiment of the present invention; and

FIG. 7 is a front view of a rear window pane of an automobile.

### DETAILED DESCRIPTION OF THE EMBODIMENTS

A terminal mounting structure for a window pane in accordance with embodiments of the present invention will be described with reference to the drawings. Same reference numerals will be used to identify similar or same elements or elements having similar functions. The components already described will be affixed with the same reference numerals and will not be particularly described again to avoid unnecessary repetition.

Turning now to FIG. 7, in accordance with an exemplary embodiment of the present invention, the terminal mounting structure serves for fixing each terminal 2 to a glass surface 1a, to provide an electric connection to defogging and deicing heating wires or antenna wires arranged on a rear window pane 1 of an automobile. In the case of defogging heating wires 3, the terminals 2 are mounted in contact with the power supply portions 4a of the busbars 4 (acting as conductive parts) provided on the glass surface 1a.

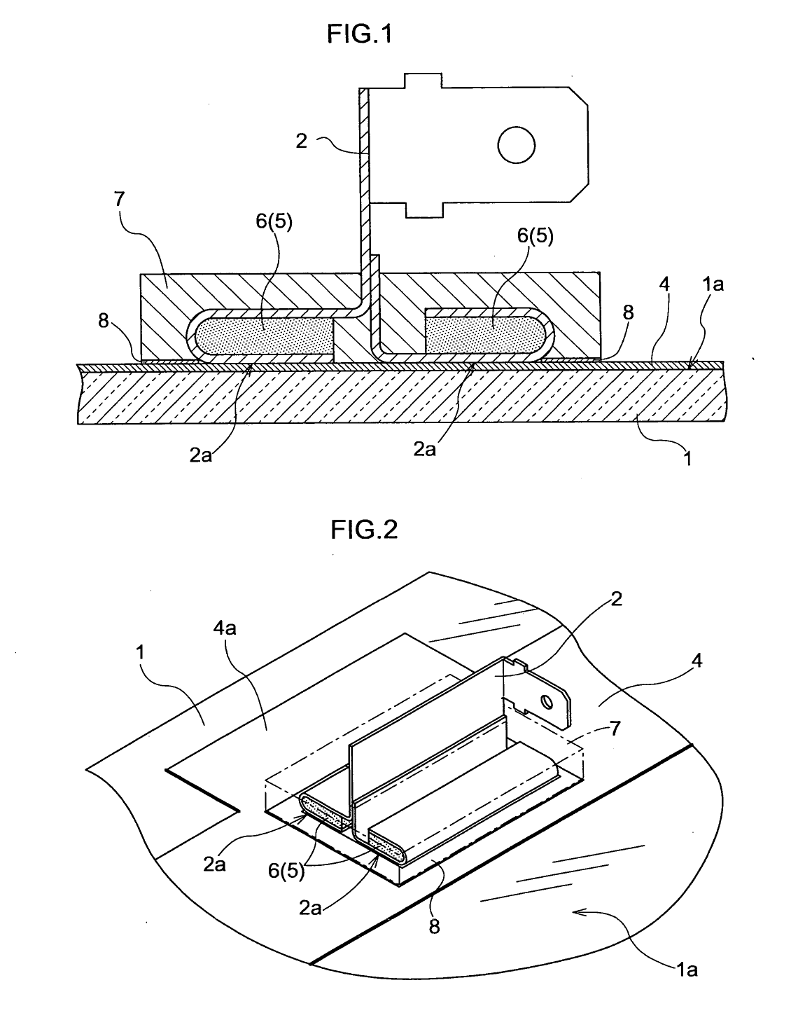

In accordance with an exemplary embodiment of the present invention, as shown in FIGS. 1 and 2, each terminal 2 comprises or is formed of a metal spring material with terminal tips 2a in contact with the busbar 4, which is bent to a U-shape.

In U-shaped hollow sections of the terminal tips 2a, deformation allowance regions 5 for allowing elastic deformation of the terminal tips 2a are formed on back surfaces of the portions in contact with the busbar 4. Specifically, these deformation allowance regions 5 are formed of soft or elastic members for allowing the portions of the terminal tips 2a in contact with the busbar 4 to make elastic deformation toward and away from the busbar 4, preferably away from the busbar 4. For example, the members forming the deformation allowance regions 5 can be elastic elements 6 made of a foamed resin such as styrene foam. The elastic elements 6 acting as the deformation allowance regions 5 are arranged in the U-shaped hollow sections of the terminal tips 2a. A resin material 7 surrounds the terminal tips 2a and elastic elements 6. The resin material 7 is bonded to the busbar 4 through an adhesive member 8 disposed around the terminal tips 2a. in this way, each terminal 2 is mounted on the glass surface 1a.

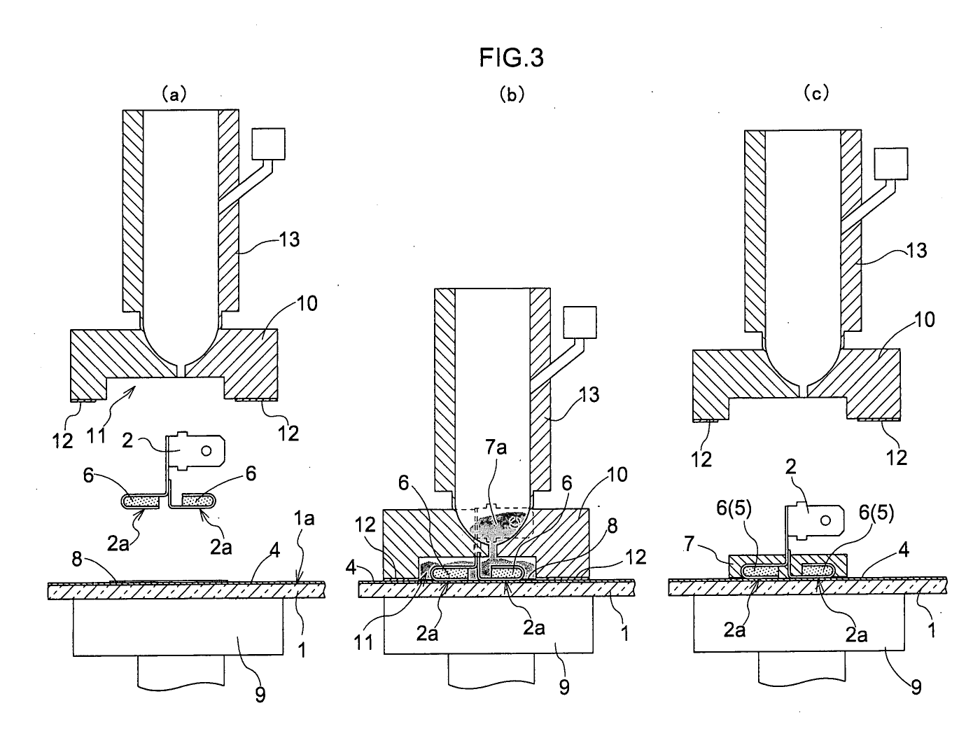

In accordance with an exemplary embodiment of the present invention, a method of manufacturing the terminal mounting structure will now be described herein. As shown in FIG. 3(a), the window pane 1 comprising busbars 4 is placed on a base 9 formed of an elastic material, such as hard rubber. The adhesive member 8 is formed beforehand on a required portion (i.e. a portion where the resin material is to be applied) of each busbar 4. For example, the adhesive member 8 is formed by applying a nylon-based adhesive to the busbar 4 with a felt and allowing the adhesive to dry.

The elastic elements 6 are then placed in the U-shaped hollow sections of the terminal tips 2a and the terminal 2 is placed in a cavity 11 of an injection molding die 10. As shown in FIG. 3(b), the die 10 is placed on the busbar 4, preferably with a buffer member 12 formed of fluoro-resin film interposed between the die 10 and busbar 4.

A melted resin 7a, e.g. a thermoplastic resin such as vinyl chloride, polypropylene or polyester, is then injected into the cavity 11 of the die 10 from an injection molding machine 13.

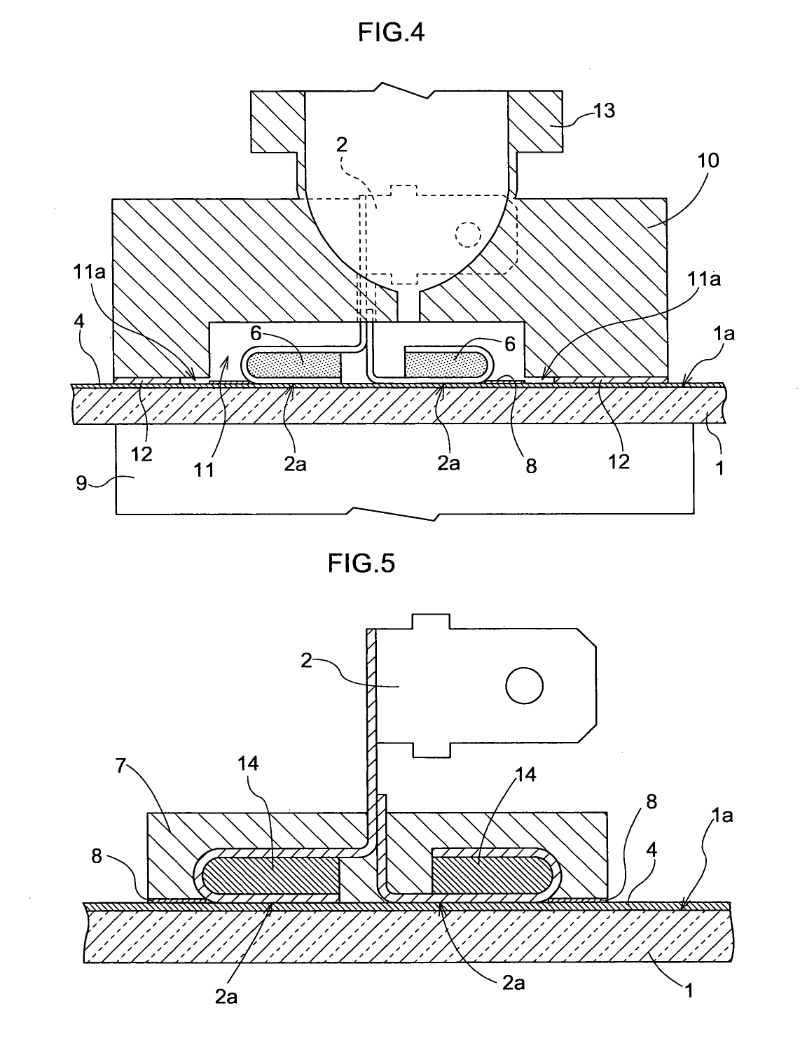

The enlarged view of the 10 is shown in FIG. 4, which is in communication with the cavity 11 required to be filled completely with the resin 7a and comprises an incomplete filling cavity 11a not required to be filled completely with the resin 7a. This enables the injection to be carried out under a low pressure in the order of 34.32 MPa (350 kgf/cm²), preferably not exceeding 19.61 MPa (200 kgf/cm²).

Subsequently, when the injected resin 7a has cooled and solidified, as shown in FIG. 3(c), the resin material 7 surrounds and attaches the terminal tips 2a and elastic elements 6 of the terminal 2. Consequently, the deformation allowance regions 5 are formed on the back surfaces of the portions of the terminal tips 2a in contact with the busbar 4.

In accordance with an exemplary embodiment of the present invention, bags containing a gas such as air in a sealed state, for example, can be used in place of the elastic elements 6. Such bags can form the deformation allowance regions 5.

In accordance with an exemplary embodiment of the present invention, each terminal 2 is formed of a metal plate other than the spring material, i.e. formed of a soft conductive material. As shown in FIG. 5, the terminal tips 2a bent to the U-shape comprises block-like elastic elements 14 formed of rubber, for example, and arranged on the back surfaces of the portions in contact with the busbar 4. The elastic elements 14 press the terminal tips 2a on the busbar 4 with elastic force.

As discussed herein, the resin materials 7 formed by injection of the melted resin 7a surrounds and mounts. However, the terminal 2 can be formed of a metal spring material, and the terminal tips 2a can be pressed on the busbar 4 by the elastic force of the terminal 2 itself as well as the elastic force of the elastic elements 14.

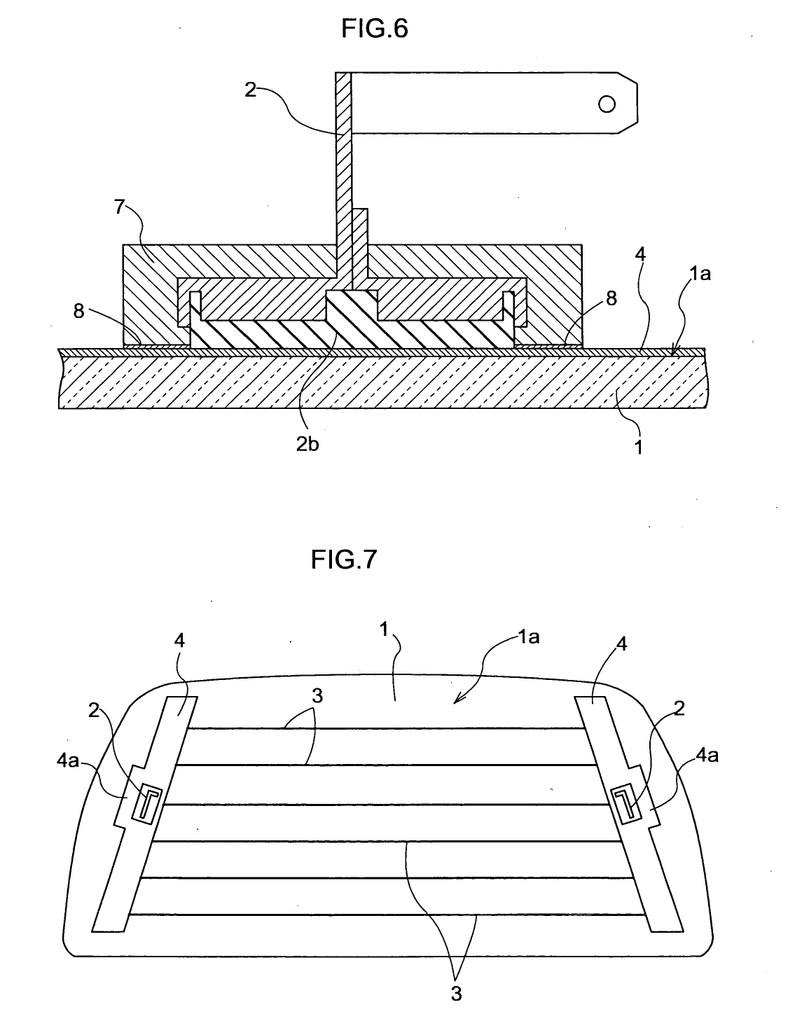

As shown in FIG. 6, in accordance with an exemplary embodiment of the present invention, each terminal 2 has a contact portion 2b formed of conductive rubber for contacting the busbar 4. The other portions are formed of an ordinary metal plate. The resin material 7 formed by injection of the melted resin 7a surrounds and attaches the contact portion 2b, i.e. the portion 2b formed of conductive rubber for contacting the busbar 4. Not only the contact portion 2b for contacting the busbar 4 but the entire terminal 2 can be formed of conductive rubber.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described herein. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A terminal mounting structure for a window pane, comprising a terminal for electric connection, which is in contact with a conductive part provided on a glass surface of the window pane and fixed to the glass surface through a resin material attached to the glass surface; and
wherein said terminal is formed of a spring material and comprises deformation allowance regions formed on back surfaces of contact portions of said terminal, which is in contact with said conductive part for allowing elastic deformation of the terminal; and wherein said resin material surrounds at least said contact portions and said deformation allowance regions of said terminal.

2. The terminal mounting structure of claim 1, wherein said terminal comprises U-shaped terminal tips.

3. The terminal mounting structure of claim 2, wherein deformation allowance region comprises elastic members for elastically deforming said terminal tips.

4. The terminal mounting structure of claim 2, wherein said deformation allowance region comprises a foamed resin.

5. The terminal mounting structure of claim 4, wherein said terminal tips comprises hollow sections; and wherein said foamed resin are arranged in said hollow sections of said terminal tips.

6. The terminal mounting structure of claim 1, wherein said resin material is formed by injection of melted resin.

7. The terminal mounting structure of claim 1, wherein said terminal provides an electric connection to defogging and deicing heating wires or antenna wires.

8. A terminal mounting structure for a window pane, comprising a terminal for electric connection, which is in contact with a conductive part provided on a glass surface of the window pane and fixed to the glass surface through a resin material attached to the glass surface; and
wherein said terminal has elastic elements arranged on back surfaces of contact portions of said terminal, which is in contact with said conductive part for pressing said terminal on said conductive part with elastic force; and wherein said resin material surrounds at least said contact portions and said elastic elements of said terminal.

9. The terminal mounting structure of claim 8, wherein said terminal comprises U-shaped terminal tips.

10. The terminal mounting structure of claim 9, wherein said terminal tips comprises hollow sections; and wherein said elastic elements are formed of rubber arranged in said hollow sections of said terminal tips.

11. The terminal mounting structure of claim 8, wherein said terminal is formed of a metal plate.

12. The terminal mounting structure of claim 8, wherein said resin material is formed by injection of melted resin.

13. The terminal mounting structure of claim 8, wherein said terminal provides an electric connection to defogging and deicing heating wires or antenna wires.

14. A terminal mounting structure for a window pane, comprising a terminal for electric connection, which is in contact with a conductive part provided on a glass surface of the window pane and fixed to the glass surface through a resin material attached to the glass surface; and
wherein said terminal has contact portions, which is in contact with said conductive part and formed of conductive rubber; and wherein said resin material surrounds at least said contact portions of said terminal.

15. The terminal mounting structure of claim 14, wherein said resin material is formed by injection of melted resin.

16. The terminal mounting structure of claim 14, wherein said terminal provides an electric connection to defogging and deicing heating wires or antenna wires.
